(19) United States
(12) Patent Application Publication
(10) Pub. No.: US 2025/0288072 A1
(43) Pub. Date: Sep. 18, 2025

(54) ROBOTIC VIDEO CAPTURE SYSTEMS AND DEVICES

(71) Applicant: Vue Events, Inc., Oxon Hill, MA (US)

(72) Inventor: William Lee Wiley, JR., Miami, FL (US)

(21) Appl. No.: 19/082,373

(22) Filed: Mar. 18, 2025

Related U.S. Application Data
(60) Provisional application No. 63/566,765, filed on Mar. 18, 2024.

(51) Int. Cl. A45C 5/04; A45C 5/14; A45C 13/02

(52) U.S. Cl. CPC A45C 5/04; A45C 5/14; A45C 13/02

(57) ABSTRACT

A robotic video capture system includes a robotic video capture device and an enclosure therefor. The enclosure can include case shells that connect to one another and to a base of the robotic video capture device to form a closed configuration. A case shell can include a support platform that supports an arm of the robotic video capture device when in the closed configuration and when the robotic video capture system is tilted to rest on rollers of the case shell. The robotic video capture device can include a pointer light on a robotic arm thereof, enabling the robotic video capture device to receive user input selecting a pose position and control the robotic arm to position the pointer light to illuminate the pose position on a surface on which a subject will stand during recording or shot acquisition.

### CROSS-REFERENCE TO RELATED APPLICATIONS

This application claims priority to and the benefit of U.S. Provisional Patent Application No. 63/566,765, filed on Mar. 18, 2024, and entitled “ROBOTIC VIDEO CAPTURE SYSTEMS AND DEVICES”, the entirety of which is incorporated herein by reference for all purposes.

### BACKGROUND

Photo and video booths are interactive setups designed for capturing moments at events through photographs or videos. Many photo and video booths offer advanced setups that can be customized with props, backdrops, special lighting, and/or specialized equipment. Such booths are popular at weddings, parties, corporate events, festivals, etc.

Setting up and/or operating such booths can be quite challenging. For instance, setting up a video booth can require understanding various technical aspects, from lighting to camera and/or other device settings. Operators often need specialized training to handle and/or set up the equipment correctly and/or troubleshoot on the spot. Furthermore, some photo and/or video booths include large and/or heavy equipment, which can make setup and/or takedown of such booths difficult to manage for a single person. Moreover, managing the flow of guests and ensuring the booth runs smoothly throughout an event adds another layer of complexity.

The subject matter claimed herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example robotic video capture system including a robotic video capture device and an enclosure, in accordance with implementations of the disclosed subject matter.

FIG. 2 illustrates an example robotic video capture system in a closed configuration and in a standing position, in accordance with implementations of the disclosed subject matter.

FIG. 3 illustrates an example robotic video capture system in a closed configuration and in a rolling position, in accordance with implementations of the disclosed subject matter.

FIG. 4 illustrates an example first case shell of an enclosure for a robotic video capture system, in accordance with implementations of the disclosed subject matter.

FIG. 5 illustrates an example first case shell of an enclosure for a robotic video capture system with a device stand retained by the first case shell, in accordance with implementations of the disclosed subject matter.

FIG. 6 illustrates an example head region of a robotic video capture device, in accordance with implementations of the disclosed subject matter.

FIGS. 7 and 8 illustrate an example display of a robotic video capture device presenting example recording paths for the robotic video capture device, in accordance with implementations of the disclosed subject matter.

FIG. 9 illustrates an example display of a robotic video capture device presenting a pose point illumination interface, in accordance with implementations of the disclosed subject matter.

FIG. 10 illustrates an example display of a robotic video capture device presenting a pose point illumination interface after selection of a pose point, in accordance with implementations of the disclosed subject matter.

FIG. 11 illustrates the robotic video capture device positioned to illuminate a selected pose point, in accordance with implementations of the disclosed subject matter.

FIG. 12 illustrates an example display of a robotic video capture device presenting a pose point illumination interface after selection of a pose point, in accordance with implementations of the disclosed subject matter.

FIG. 13 illustrates the robotic video capture device positioned to illuminate a selected pose point, in accordance with implementations of the disclosed subject matter.

FIG. 14 conceptually depicts an example recording performed using the robotic video capture device, in accordance with implementations of the disclosed subject matter.

FIG. 15 depicts example components of a system that may comprise or be configurable to perform various embodiments.

### DETAILED DESCRIPTION

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method, which may be implemented, at least in part, using data on a tangible computer-readable medium.

Components, or modules, shown in diagrams are illustrative of example embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or similar terms shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” “implementation(s)”, “example(s)”, “instance(s)” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

Any specific embodiment described herein is not necessarily limited strictly to the features expressly described for that specific embodiment and may also (or alternatively) include properties and/or features (e.g., ingredients, components, members, elements, parts, and/or regions) described for one or more separate embodiments. Accordingly, the various features of a given embodiment can be combined with and/or incorporated into other embodiments described herein. Disclosure of certain features relative to a specific embodiment of the present disclosure should not be construed as limiting application or inclusion of said features to the specific embodiment. Rather, it will be appreciated that other embodiments can also include such features.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded. A set may contain any number of elements, including the empty set.

Unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

As used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

One skilled in the art shall recognize, in view of the present disclosure, that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

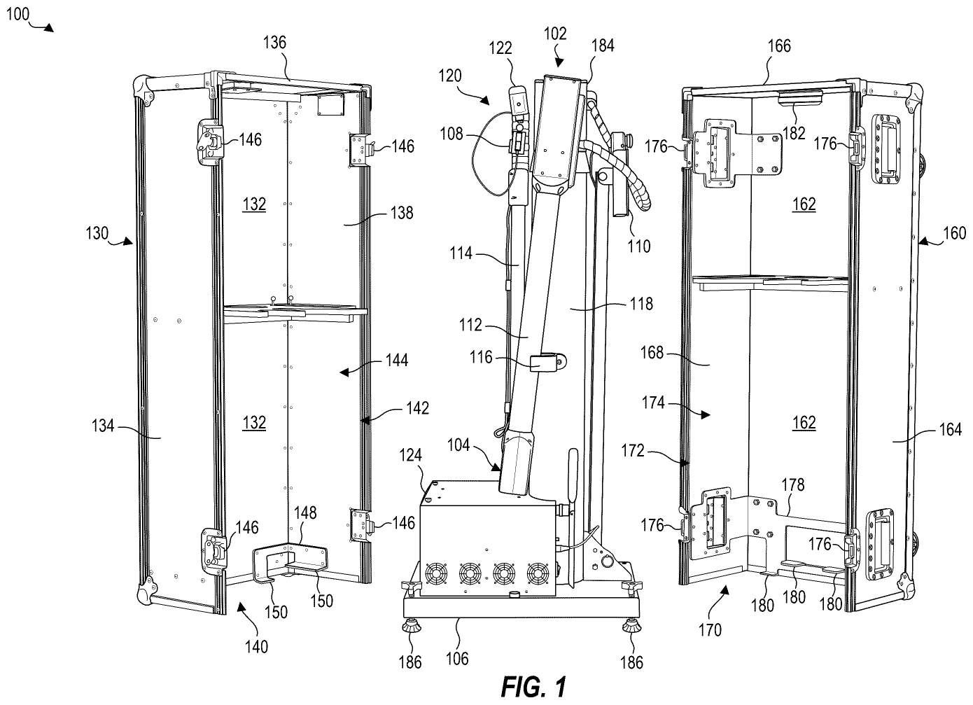

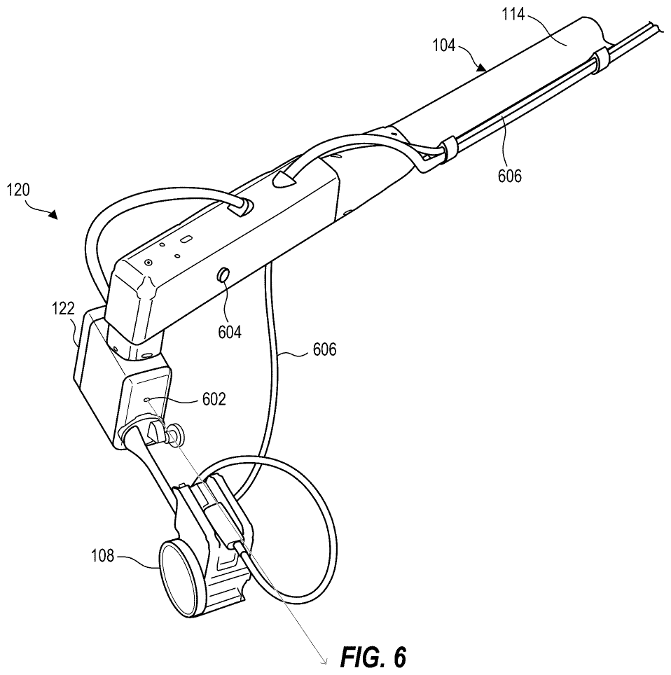

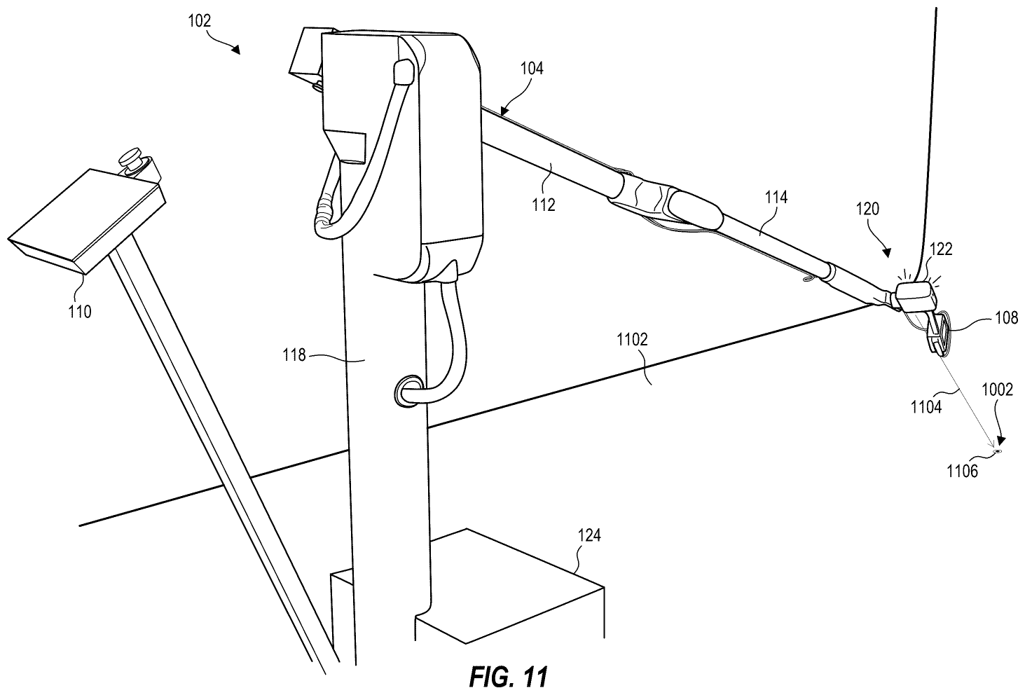

FIG. 1 illustrates an example robotic video capture system 100 including a robotic video capture device 102 and an enclosure, in accordance with implementations of the disclosed subject matter. The robotic video capture device 102 can comprise a robotic arm 104 (including any quantity of arm segments) that is connected to a base 106. The robotic video capture device 102 can further include a video capture device 108 connected to the robotic arm 104 (see also FIG. 6), enabling the video capture device 108 to be repositionable via control of the robotic arm 104. In some implementations, the robotic arm 104 comprises a 6 degree of freedom (6 DOF) robotic arm. The robotic video capture device 102 can further include a control interface 110 (see also FIG. 11) for facilitating control and/or configuring of the robotic arm 104 and/or the video capture device 108 (and/or other components of the robotic video capture device 102). The control interface 110 can comprise a display for presenting information to users/operators and an input system for receiving user input. In one example, the control interface 110 can comprise a touch screen interface adapted to display information and receive touch input.

The video capture device 108 can take on various forms, such as a consumer electronic device with image and/or video capture capabilities (e.g., a GoPro, iPhone, or other device), which can be controlled to acquire videos as the robotic arm 104 moves. The robotic arm 104 can be configured move along a recording path that can be predefined or preset. The robotic arm 104 can be controlled, configured, setup, maintained, etc. by the control interface 110 and/or one or more other connected control devices (e.g., to facilitate recording in sync with movement of the robotic arm) via internal, externally wired connection and/or via wireless connections, which can utilize Bluetooth low energy (BLE) or other connection protocol (e.g., a TCP-based protocol).

The robotic arm 104 can include one or more tracking devices, such as one or more built-in encoders to track the movement of the robotic arm 104 in various movement dimensions. In some instances, the positioning of the robotic arm 104 can be initially established to facilitate proper movement tracking functionality. For example, to establish a “home” position, the robotic arm 104 can be configured to enter a “glide mode”, where the motors are disabled and the brakes are released, allowing the user to move the robotic arm 104 freely. In some implementations, the glide mode can be enabled by pressing a button or other control mechanism on the head region 120 (or other portion) of the robotic arm 104 for a predetermined time period (e.g., 0.5 seconds). Such a control input can initiate a warning sequence (e.g., warning beeps, light flashes) to alert the user prior to activation of the glide mode.

In some instances, when in the glide mode, the user can move portions of the robotic arm 104 to rest or “home” positions defined by structural features of the robotic arm. For example, when in the glide mode, a user can reposition segments 112 and 114 to rest or reside in a bracket 116 connected to an arm 118 of the robotic video capture device 102 that extends from the base 106. One or more sensors can be arranged on the robotic arm 104 and/or the bracket 116 to determine when the segments 112 and 114 of the robotic arm 104 have reached their rest or “home” positions (e.g., one or more Hall sensors can be positioned on the bracket 116 to indicate when the segments 112 and 114 have reached the home position, which can trigger activation of one or more indicators such as LEDs on the bracket 116 or another part of the robotic video capture device 102 to designate correct placement). One or more additional sensors can indicate when a head region 120 of the robotic arm 104 has reached the home position(s), which can cause one or more indicators such as a cue light 122 on the head region 120 to reflect correct placement/orientation. Additional control input (e.g., a second press of a button on the head of the robotic arm) can remove the robotic arm from the glide mode.

The robotic video capture device 102 can include an internal cellular/Wi-Fi/Ethernet router/switch, or other communication platform (e.g., integrated into a hub 124 connected to the base 106), which can allow for quick event setup and/or hardwired ethernet connections to local devices. The communication platform can provide “Wi-Fi as WAN,” cellular, other wireless, and/or hardwired ethernet connections to facilitate connection to a wide area network.

The hub 124 of the robotic video capture device 102 can include one or more connection ports to provide a built-in interface for a GoPro or other USB-controlled camera. The connection port(s) can be powered by a full 100 W and can provide 60 W to an external camera controlling device, such as an iPad or laptop (e.g., connectable to a device stand 502, as described herein). The hub 124 can also comprise an ethernet switch/router to provide an external controlling device with internet access. For instance, the hub 124 can provide power to an additional device (e.g., an iPad or other user device) which can be used to control at least some operations of the robotic video capture device 102 (e.g., shot acquisition) and/or can function as a “sharing station” where users can review and share their videos after video acquisition via the robotic video capture device 102. The directly wired connection facilitated by the hub 124 (and wiring 606, as described hereinafter) can provide power and communication to various device(s), which can avoid issues with charging and/or interference when using wireless connections.

In some implementations, a robotic video capture device 102 include or communicate with one or more wireless key fobs or other wireless control devices to start/stop movement of the robotic arm and/or recording via the connected video capture device 108 to facilitate video acquisitions/shots. In this regard, in some instances, operation of a robotic video capture system to facilitate video acquisitions/shots can be controlled by multiple device modalities (e.g., an iPad or additional control device connected via one or more hubs, one or more wireless key fobs, etc.), which can facilitate operational versatility (e.g., enabling subjects to hold a control device and provide input to initiate video acquisition, which can improve shot coordination with subjects).

FIG. 1 further illustrates the robotic video capture system 100 as including an enclosure that can include multiple parts, such as a first case shell 130 and a second case shell 160. Although only two case shells are shown in the example of FIG. 1, an enclosure for a robotic video capture device 102 can include any quantity of case shells.

In the example shown in FIG. 1, the first case shell 130 includes a plurality of shell walls, including a first shell wall 132, a second shell wall 134, a third shell wall 136, and a fourth shell wall 138. In the illustrated example, the second shell wall 134, the third shell wall 136, and the fourth shell wall 138 are connected to and/or extend from respective edges of the first shell wall 132 (e.g., substantially perpendicular to the first shell wall 132), forming a generally rectangular prismatic shape that defines a first open side 140 and a second open side 142 that reveal or expose a first interior 144 (e.g., when the enclosure is in an open configuration as shown in FIG. 1). Similarly, in the example shown in FIG. 1, the second case shell 160 includes a plurality of shell walls, including a fifth shell wall 162, a sixth shell wall 164, a seventh shell wall 166, and an eighth shell wall 168. In the illustrated example, the sixth shell wall 164, the seventh shell wall 166, and the eighth shell wall 168 are connected to and/or extend from respective edges of the fifth shell wall 162 (e.g., substantially perpendicular to the fifth shell wall 162), forming a generally rectangular prismatic shape that defines a third open side 170 and a fourth open side 172 that reveal or expose a second interior 174 (e.g., when the enclosure is in an open configuration as shown in FIG. 1).

One will appreciate, in view of the present disclosure, that the specific shapes and/or sizes of the first and second case shells 130 and 160 of the enclosure for the robotic video capture device 102 are provided by way of example only and can be varied within the scope of the disclosed subject matter (e.g., case shells can comprise curved and/or rounded shapes that connect together to enclose about the base 106 of the robotic video capture device 102).

FIG. 1 illustrates that the first case shell 130 and the second case shell 160 can include respective sets of interlock features 146 and 176. When the first case shell 130 and the second case shell 160 are brought together (e.g., or when the second open side 142 becomes aligned with the fourth open side 172), the set of interlock features 146 of the first case shell 130 may be configured to selectively engage with the set of interlock features 176 of the second case shell 160 to facilitate securement of the first case shell 130 to the second case shell 160. The sets of interlock features 146 and 176 can take on any suitable form, such as a latch-based mechanism (e.g., a multi-axis rotary latch), a clamp-based mechanism, a threaded and/or fastener-based mechanism, and/or others. In the example shown in FIG. 1, the set of interlock features 146 includes interlock features arranged on the second shell wall 134 and the fourth shell wall 138, whereas the set of interlock features 176 includes interlock features arranged on the sixth shell wall 164 and the eighth shell wall 168. Other quantities and arrangements/positionings of the individual interlock features of the sets of interlock features 146 and 176 are within the scope of the present disclosure.

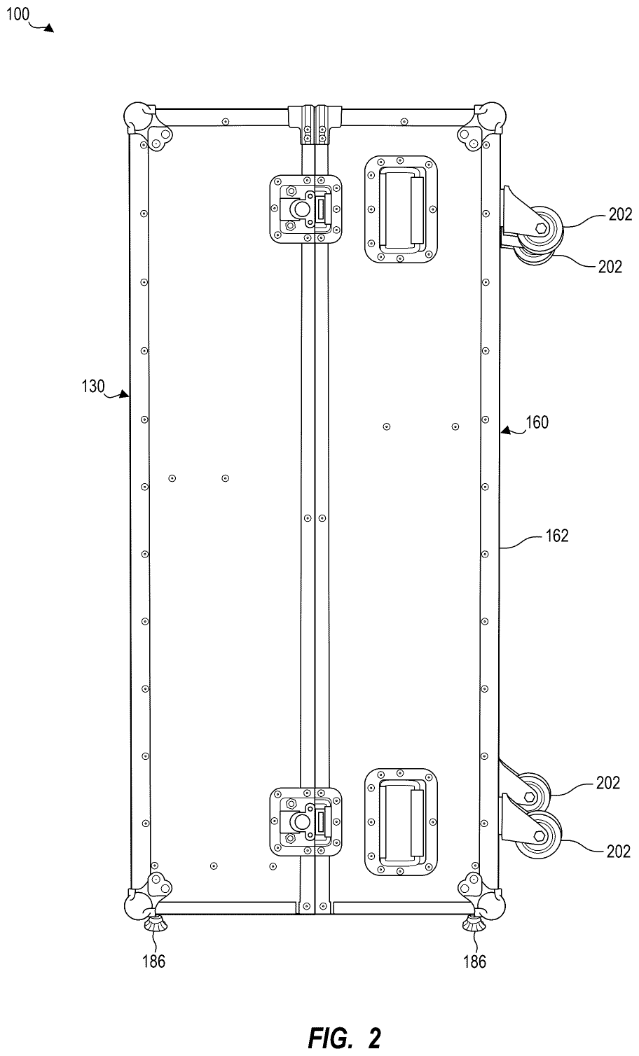

The example first and second case shells 130 and 160 of the robotic video capture system 100 shown in FIG. 1 can include respective engagement mechanisms that enable the first and second case shells 130 and 160 to engage with the base 106 of the robotic video capture device 102 when the base 106 is at least partially brought within (i) the first open side 140 of the first case shell 130 and (ii) the third open side 170 of the second case shell 160. For instance, FIG. 1 illustrates the first case shell 130 as including a first bracket assembly 148 that is at least partially positioned within the first interior 144 defined by the first case shell 130. The first bracket assembly 148 may include a set of engagement features 150 that are configured to engage with a part of the base 106 (e.g., when the part of the base 106 becomes positioned at or within the first open side 140). For instance, the set of engagement features 150 shown in FIG. 1 are implemented as one or more upper protrusions and one or more lower protrusions that are defined by the first bracket assembly 148 and that extend inward from one or more shell walls of the first case shell 130. In the example shown in FIG. 1, when the first open side 140 of the first case shell 130 receives the base 106 of the robotic video capture device 102, the upper protrusion(s) are sized and positioned to become arranged over the top of the base 106, whereas the lower protrusion(s) are sized and positioned to become arranged below the bottom of the base 106, allowing the upper and lower protrusions to constrain movement of the base 106 along the longitudinal direction of the first case shell 130 (e.g., along the vertical direction as shown in FIGS. 1 and 2).

Similarly, FIG. 1 illustrates the second case shell 160 as including a second bracket assembly 178 that is at least partially positioned within the second interior 174 defined by the second case shell 160. The second bracket assembly 178 may include a set of engagement features 180 that are configured to engage with a part of the base 106 (e.g., when the part of the base 106 becomes positioned at or within the third open side 170). For instance, the set of engagement features 180 shown in FIG. 1 are implemented as one or more upper protrusions and one or more lower protrusions that are defined by the second bracket assembly 178 and that extend inward from one or more shell walls of the second case shell 160. In the example shown in FIG. 1, when the third open side 170 of the second case shell 160 receives the base 106 of the robotic video capture device 102, the upper protrusion(s) are sized and positioned to become arranged over the top of the base 106, whereas the lower protrusion(s) are sized and positioned to become arranged below the bottom of the base 106, allowing the upper and lower protrusions to constrain movement of the base 106 along the longitudinal direction of the first case shell 130 (e.g., along the vertical direction as shown in FIGS. 1 and 2).

In some implementations, the sets of engagement features 150 and 180 of the first and second bracket assemblies 148 and 178, respectively, may become engaged with the base 106 as described above when the first case shell 130 and the second case shell 160 are enclosed about the robotic video capture device 102 and when the set of interlock features 146 is engaged with the set of interlock features 176 (e.g., when the second shell wall 134 interfaces with the sixth shell wall 164, the third shell wall 136 interfaces with the seventh shell wall 166, and the fourth shell wall 138 interfaces with the eighth shell wall 168), as illustrated in FIG. 2. Under the configuration shown in FIG. 2, the base 106 may be retained between upper and lower protrusions of the first and second bracket assemblies 148 and 178 (e.g., to constrain vertical movement of the base 106 relative to the enclosure from the perspective shown in FIG. 2) and between the shell walls of the first case shell 130 and the second case shell 160 (and/or the first bracket assembly 148 and/or second bracket assembly 178 placed thereover) (e.g., to constrain lateral movement of the base 106 relative to the enclosure from the perspective shown in FIG. 2).

The first and second bracket assemblies 148 and 178 can include any quantity of separate bracket elements, and the sets of engagement features 150 and 180 can be distributed among the bracket elements in any manner.

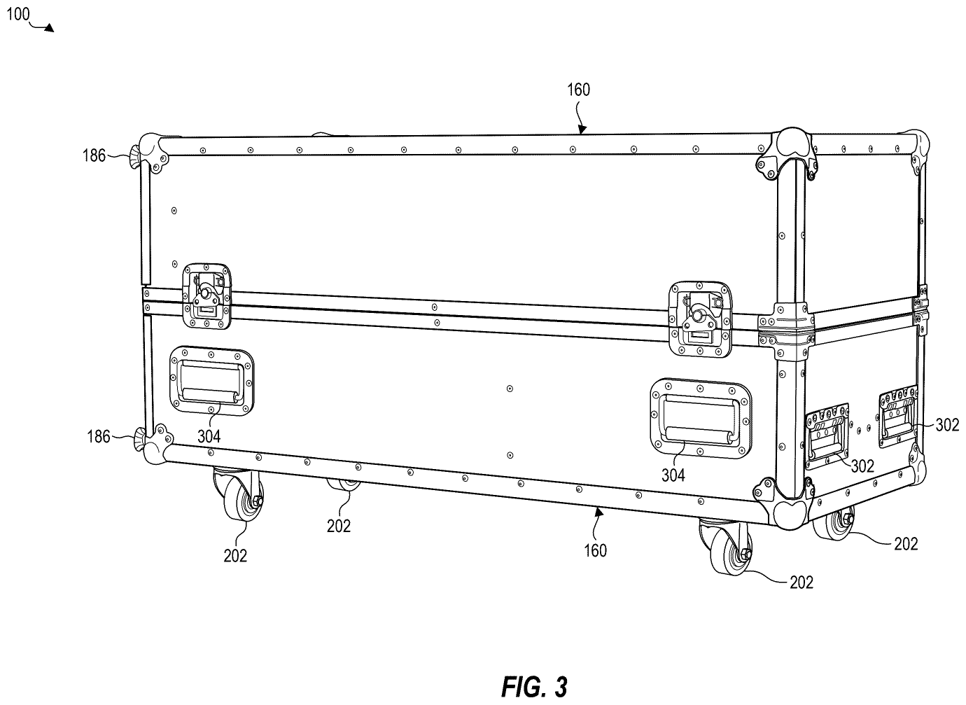

In the example shown in FIG. 2, the second case shell 160 includes roller elements 202 connected to the second case shell 160 (e.g., connected to the fifth shell wall 162). With the first case shell 130 and the second case shell 160 connected to one another and enclosing the robotic video capture device 102 (e.g., as shown in FIG. 2), the robotic video capture system 100 may be tilted or pivoted to allow the roller elements 202 to support the robotic video capture device 102 housed by the enclosure. For instance, FIG. 3 illustrates the robotic video capture system 100 in a tilted configuration, with the first case shell 130 vertically positioned over the second case shell 160 (from the perspective shown in FIG. 3) while both the first and second case shells 130 and 160 enclose the robotic video capture device 102. From the position shown in FIG. 3, the roller elements 202 support the weight of the robotic video capture device 102 (and the enclosure), allowing the robotic video capture system 100 to be conveniently rolled between locations.

In the example shown in FIG. 3, the robotic video capture system 100 includes handles 302 for assisting users in repositioning the enclosure from a tilted or first position (shown in FIG. 3) to a vertical or second position (shown in FIG. 2), and vice-versa. The tilted or first position may be characterized by the roller elements 202 supporting the weight of the enclosure and/or the robotic video capture device 102, making the robotic video capture system 100 ready for movement via rolling. The vertical or second position may be characterized by the base 106 of the robotic video capture device 102 supporting the weight of the enclosure.

To facilitate transitioning from the tilted or first position (shown in FIG. 3) to the vertical or second position (shown in FIG. 2), a user may grip the handles 302 and exert upward force thereon, causing the roller elements 202 that are nearer to the handles 302 to lift off the ground and allowing the base 106 to pivot into a facing configuration with the ground, ultimately reaching the vertical or second position with the base 106 supporting the weight of the enclosure and the other components of the robotic video capture device 102. To facilitate transitioning from the vertical or second position to the tilted or first position, a user may grip the handles 302 to exert a horizontal force thereon, causing the base 106 to pivot out of a facing configuration with the ground and causing the roller elements 202 that are nearer to the base 106 to come into contact with the ground and begin supporting the weight of the robotic video capture system 100. During this pivoting, the user may transition to applying an upward force on the handles 302 to ease the robotic video capture system 100 into being supported by the remaining roller elements 202 (e.g., the roller elements 202 that are nearer to the handles 302), ultimately reaching the tilted or first position (shown in FIG. 3).

The enclosure of the robotic video capture system 100 may include one or more features for supporting components of the robotic video capture device 102 in addition to the base 106 when in the tilted or first position (or when approaching the tilted or first position). For instance, FIG. 1 illustrates the second case shell 160 as including a support platform 182 that is arranged within the second interior 174 (e.g., opposite the third open side 170, or on the seventh shell wall 166). The support platform 182 is configured to support the arm 118 of the robotic video capture device 102 that extends from the base 106. For instance, when in the tilted or first position (shown in FIG. 3), a region 184 of the arm 118 shown in FIG. 1 may rest on the support platform 182, which can improve distribution of load from the robotic video capture device 102 to the second case shell 160.

Under the configuration shown and described with reference to FIGS. 1-3, the base 106 can cooperate with the first case shell 130 and the second case shell 160 to facilitate enclosure of other components of the robotic video capture device 102. By effectively using the base 106 as a wall when enclosing the robotic video capture device 102, users can avoid lifting the robotic video capture device 102 into a case to facilitate enclosure thereof. These features, in combination with the handles 302 and the roller elements 202 for facilitating tilting and/or rolling transportation of the robotic video capture system 100, can advantageously enable a single user to transport, open, set up, operate, take down, enclose, and again transport the robotic video capture system 100 (e.g., pursuant to operating a video capture booth).

Although FIG. 3 illustrates the robotic video capture system 100 as including two handles 302 positioned on the seventh shell wall 166 for facilitating tilting of the robotic video capture system 100 as described above, an enclosure for a robotic video capture device 102 can include any quantity of handles on any surfaces thereof for this purpose. Furthermore, the enclosure of the robotic video capture system 100 can include additional handles, such as handles 304 shown in FIG. 3 on the eighth shell wall 168 for facilitating lifting of the robotic video capture system 100 (e.g., additional handles may be positioned on the sixth shell wall 164).

As noted above, the second case shell 160 can include roller elements 202 placed thereon to facilitate transportation of the robotic video capture system 100. By incorporating the roller elements 202 on the second case shell 160 (or another part of the enclosure), the base 106 may omit rolling elements, as shown in FIG. 1. Instead, as shown in FIG. 1, the base 106 may include leveling features 186, which can enable users to adjust the leveling of the robotic video capture device 102 in preparation for video capture tasks.

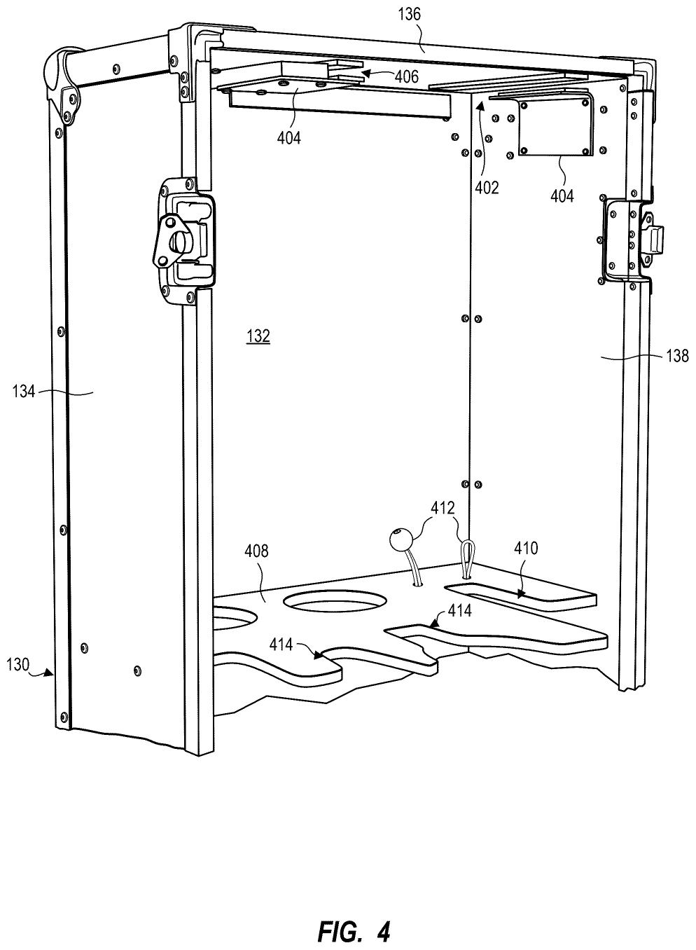

The enclosure (e.g., the first case shell 130 and the second case shell 160) can include additional space for housing additional components associated with performance of the robotic video capture device 102. For instance, FIG. 4 illustrates the first case shell 130 of the robotic video capture system 100. In the example shown in FIG. 4, the first case shell 130 includes a base plate retainer 402, which can be arranged within the first interior 144 (e.g., on the third shell wall 136, or opposite the first open side 140). The base plate retainer 402 may be configured to receive and retain a base plate of a device stand (e.g., an iPad stand, or stand adapted to support any type of user device). The device stand can be adapted to support a user device (e.g., an iPad) for interoperation with the robotic video capture device 102 (e.g., to facilitate control, configuration, setup, synchronization, etc. of the robotic video capture device 102 and/or components thereof, or to facilitate editing, sharing, exporting, downloading, etc. of content captured via the robotic video capture device 102).

In the example shown in FIG. 4, the base plate retainer 402 comprises one or more brackets 404 (or other features) that define a slot 406 for receiving the base plate of the device stand (e.g., by laterally sliding the base plate into the slot 406). Other configurations for the base plate retainer 402 are within the scope of the present disclosure (e.g., clamp, actuator, tie, rotational/pivot, or other retention mechanisms). FIG. 4 furthermore illustrates an example in which the second case shell 160 includes a receiver panel 408 positioned at least partially within the first interior 144. The receiver panel 408 may comprise a riser slot 410 configured for receiving a riser (or stem/neck) of the device stand (e.g., when the base plate of the device stand is retained by the base plate retainer 402). The receiver panel 408 can further comprise one or more riser retention features 412, which can retain the riser of the device stem when positioned within the riser slot 410. In the example shown in FIG. 4, the riser retention feature(s) 412 is implemented as a bungee ball fastener, though other types of retention features may be used. In some implementations, the receiver panel 408 may include one or more additional slots 414 configured to receive one or more components of the robotic video capture device 102 such as the segments 112 and/or 114.

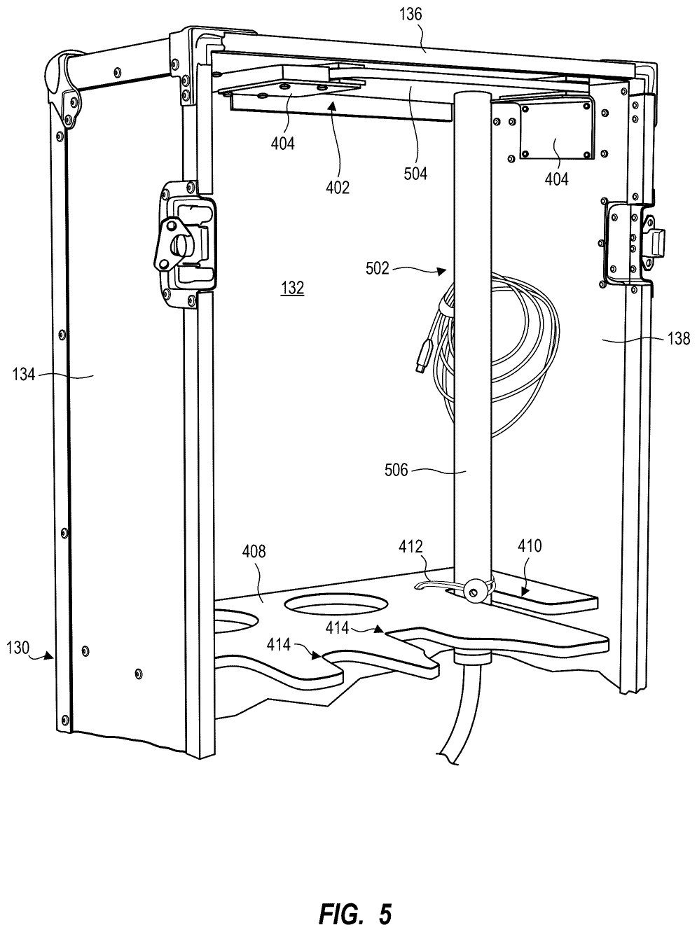

FIG. 5 illustrates an example of a device stand 502 retained by the base plate retainer 402 and the receiver panel 408, with the base plate 504 of the device stand 502 positioned within the slot 406 defined by the base plate retainer 402 and with the riser 506 of the device stand 502 positioned within the riser slot 410 and retained by the riser retention feature(s) 412 of the receiver panel 408. One will appreciate, in view of the present disclosure, that the enclosure of the robotic video capture system 100 can include one or more additional features on the first case shell 130 and/or on the second case shell 160 for retaining other components, such as lighting and/or stands therefor, screens/backdrops and/or stands therefor, and/or other accessories. For instance, the first case shell 130 and/or the second case shell 160 can include receiver panels with additional slots/holes and/or retention features thereon for receiving and securing light stands and/or other elongated components. The first case shell 130 and/or the second case shell 160 can additionally or alternatively include retention members/features arranged on one or more of the shell walls thereof for receiving and securing components/accessories independent of the receiver panels. In some implementations, the first case shell 130 and/or the second case shell 160 can additionally or alternatively include one or more cabinets, drawers, and/or containers affixed to one or more of the shell walls thereof for receiving and/or securing other components and/or accessories associated with the robotic video capture device 102.

FIG. 6 illustrates the head region 120 of the robotic arm 104 of the robotic video capture device 102. In the example shown in FIG. 6, the video capture device 108 is connected to the head region 120 of the robotic arm 104, allowing positioning of the video capture device 108 to be modifiable via the robotic arm 104, enabling the video capture device 108 to capture video while the robotic arm 104 moves. In some implementations, the robotic video capture device 102 further includes a pointer light 602, which may be arranged on the head region 120 as shown in FIG. 6. The pointer light may take on various forms, such as a laser or laser pointer, a flashlight with a focused beam, a spotlight, a pinpoint LED, a projector, and/or others. Although FIG. 6 illustrates the video capture device 108 and the pointer light 602 positioned on the head region 120 of the robotic arm 104, the video capture device 108 and/or the pointer light 602 may be positioned on any part of the robotic arm 104 and/or other components of the robotic video capture device 102.

FIG. 6 illustrates additional features of the robotic video capture device 102 that may be mounted on or interact with the head region 120 of the robotic arm 104. For instance, FIG. 6 illustrates the cue light 122 connected to the head region 120. The cue light 122 the comprise any quantity of LEDs (or other types of light sources) and can be used to communicate various information associated with the robotic video capture device 102 and/or its operation. For instance, the cue light 122 may be used to communicate aspects of a shot to a subject a (e.g., via a blink sequence when starting the shot and/or by holding a color (or white) while recording). As another example, the cue light 122 can communicate the status of the robotic video capture device 102 and/or one or more components thereof, operational modes of the robotic video capture device 102, “homing” events as discussed herein, and/or other information. In some instances, the head region 120 (or another part of the robotic video capture device 102) can include one or more speakers configured to emit sounds to communicate information to users (e.g., in cooperation with the cue light 122).

By way of illustrative, non-limiting example, the cue light 122 (and/or one or more speakers of the robotic video capture device 102) can be configured to exhibit the following behaviors to communicate the following state or information:

| State/Information | Cue Light Behavior (speaker behavior) |
|---|---|
| Off | Light off |
| Waiting - not homed | Orange slow pulse |
| Waiting - homed | Blue slow pulse |
| Glide mode - not homed | Solid orange (audible beeps before releasing |
| | brake and relaxing arm) |
| Glide mode - homed | Solid green (audible beep when leaving glide |
| | mode) |
| Return to start position | Purple pulse; (audible beeps when descending |
| | to start position) |
| Countdown | 3x white flashes over 3 seconds (audible beeps |
| | accompanying each flash) |
| Recording | Solid red |
| Emergency stop | Bright solid red - 3 pulses |
| Waiting for input | Pulse green |

In some implementations, a robotic video capture system can additionally or alternatively include one or more portable cue lights that are not physically tethered to the robotic arm but that perform similar functions to those described herein for the cue light 122. Such portable cue lights can be beneficial for shots that initiate with the subject looking away from the robotic arm 104, enabling positioning of a cue light within the subject's initial field of view at the start of the shot even when the robotic arm 104 is not within the subject's initial field of view.

FIG. 6 illustrates an example control 604 (e.g., implemented as a button, though other forms are possible) on the head region 120 of the robotic arm 104, which can be pressed to facilitate transitioning into and/or out of the glide mode (as described hereinabove, where the motors/brakes become disengaged). As indicated above, the cue light 122 can provide warning flashes preceding entry into the glide mode (and/or one or more speakers may provide an audible warning).

FIG. 6 illustrates that the robotic video capture device 102 can include wiring 606 (e.g., USB wiring, optical cabling/wiring, or other cabling/wiring) that extends from the video capture device 108 to one or more connection/communication interfaces of the robotic video capture device 102. In the example shown in FIG. 6, the wiring 606 extends from the video capture device 108 through and/or along the robotic arm 104 to reach other connection/communication interfaces of the robotic video capture device 102 (e.g., on the hub 124). The wiring 606 can directly connect the video capture device 108 to other components of the robotic video capture device 102 to enable the video capture device 108 to remain powered/charged while at the head region 120 of the robotic arm 104 during video captures sessions, and/or to facilitate communication with and/or control of the video capture device 108 during video capture sessions. In some implementations, the robotic video capture device 102 includes a 24 VDC to 5 VDC converter (e.g., implemented at the hub 124, at the head region 120, or at another location on the robotic video capture device 102) that allows USB power to be provided to the video capture device 108 at the head region 120 via the wiring 606. Other starting and output voltages/wattages are within the scope of the present disclosure (e.g., any combination allowed by the USB specification, or other combinations).

As indicated above, a robotic video capture device 102 can store multiple move sets (e.g., “predetermined motion paths”, “preset camera paths”, or “preset recording paths”) as part of robot configuration to be implemented during video capture sessions. The preset camera paths can be pre-coded into the robotic video capture system prior to shipment to end users.

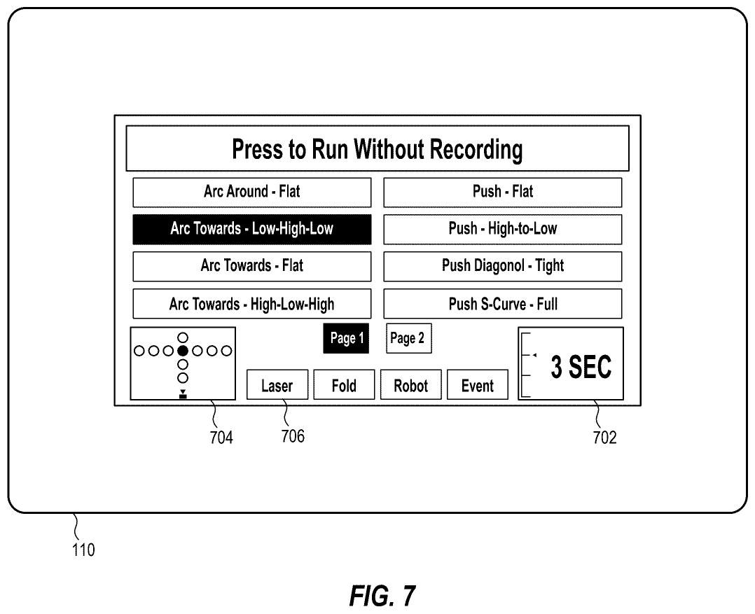

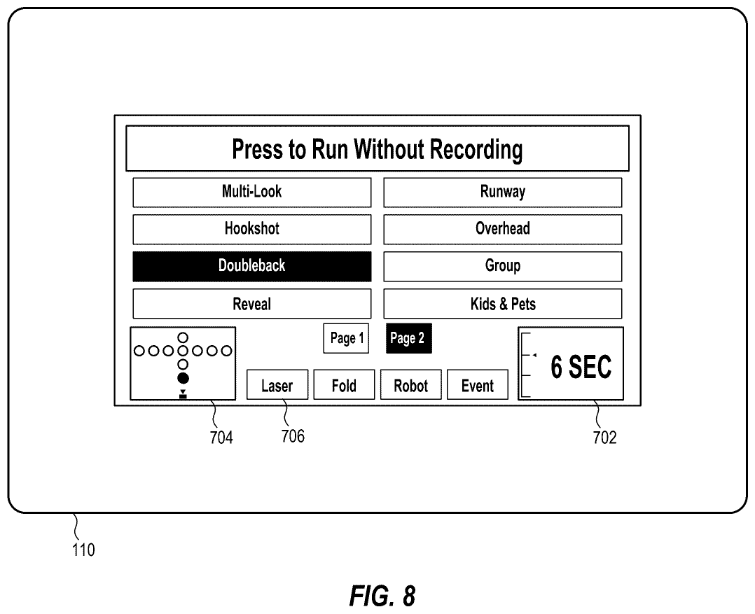

FIGS. 7 and 8 illustrate the control interface 110 of the robotic video capture device 102 presenting example recording paths. In the example shown in FIGS. 7 and 8, the preset recording paths include: arc around—flat, arc towards—low-high-low, arc towards—flat, arc towards—high-low-high, push—flat, push-high-to-low, push diagonal—tight, push s-curve—full, multi-look, hookshot, doubleback, reveal, runway, overhead, group, and kids & pets. Additional or alternative preset recording paths may be implemented via a robotic video capture device 102 in accordance with the disclosed subject matter. FIGS. 7 and 8 illustrate that the control interface 110 can display information associated with a selected preset recording path, such as duration information 702 or pose point information 704.

In some implementations, the preset camera/recording paths may be executed by the robotic video capture device 102 in accordance with pre-shot adjustment choices, which can be selected by end users via the control interface 110 (or another control device/interface, such as a connected device supported by the device stand 502 and connected to the hub 124). Example preset adjustment choices (shown in FIG. 1 on the right side of the screen) can include the height of the subject(s) to be captured, the quantity of subjects to be captured (e.g., group size), the speed at which the robotic arm 104 will traverse the recording path (e.g., slow, medium, fast), the quantity or position of turning/transition points along the recording path, shot angle or field of view settings for recording path, and/or no-go zones or planes (e.g., ceiling height, distance to and/or positioning of one or more other obstructions such as walls, furniture, etc., which can lock out camera motions or entire movement paths that would cause collisions). In some instances, the control interface 110 can prompt the user to confirm that nearest distances to walls or other objects, heights of ceilings, and/or other metrics satisfy one or more thresholds or requirements. Pre-shot adjustment choices can be selected for an individual shot, for an entire session of shots (e.g., at device startup), etc. In some implementations, preset camera paths and/or pre-shot adjustment choices can be added or updated (e.g., via a network connection such as an over-the-air update, via physical connection to an external device, etc.), which can enable customization for particular use environments (e.g., particular clients) and/or distribution of additional preset camera paths as add-ons.

The various preset recording paths and/or pre-shot adjustment choices implementable via the robotic video capture device 102 can be associated with various pose points, where subjects are intended to be positioned during shot acquisition. The control interface 110 (or another control device connected to the robotic video capture device 102) can advantageously provide functionality for controlling the robotic arm 104 and the pointer light 602 to indicate such pose points in the physical space surrounding the robotic video capture device 102, which can greatly assist users in preparing for shot acquisition.

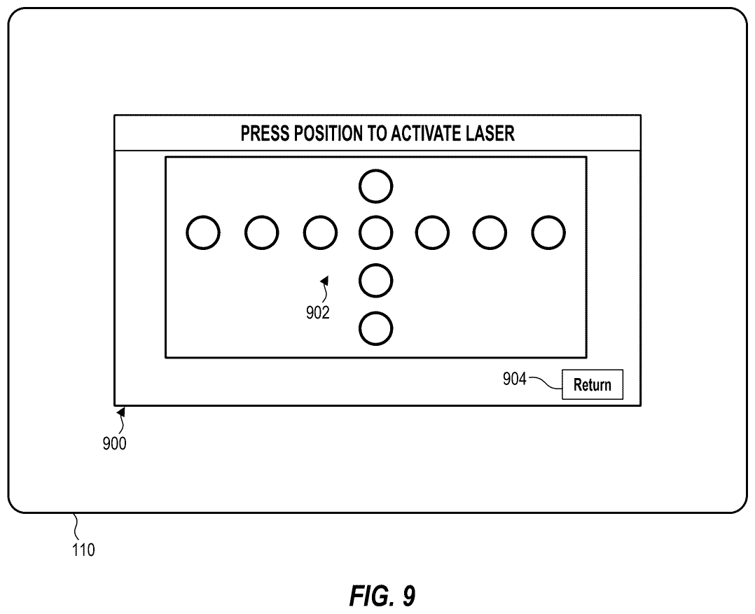

FIG. 9 illustrates the control interface 110 presenting a pose point illumination interface 900. In some implementations, the pose point illumination interface 900 can be presented on the control interface 110 after selection of the point information 704, another selectable element shown on the control interface 110 (e.g., element 706), or another control input (e.g., a button on the robotic video capture device 102). The pose point illumination interface 900 conceptually depicts a set of pose points 902, indicated in the example shown in FIG. 9 by an arrangement of circles with each circle representing a respective pose point. Each pose point represented in the set of pose points 902 indicates an intended position for a subject to be captured via the robotic video capture device 102. For instance, the intended position for a subject to be captured via the robotic video capture device 102 can comprise a location on or over a surface or floor that is in proximity to the robotic video capture device 102. In some implementations, the surface or floor on which the intended position for the subject(s) is indicated can comprise the same surface or floor on which the robotic video capture device 102 is or will be positioned during acquisition of the shot. As indicated above, the preset recording paths executable via the robotic video capture device 102 can be associated with one or more pose points represented in the set of pose points 902 (e.g., where multiple subjects are intended to be captured in a preset capture path, multiple pose points may be associated with the preset capture path).

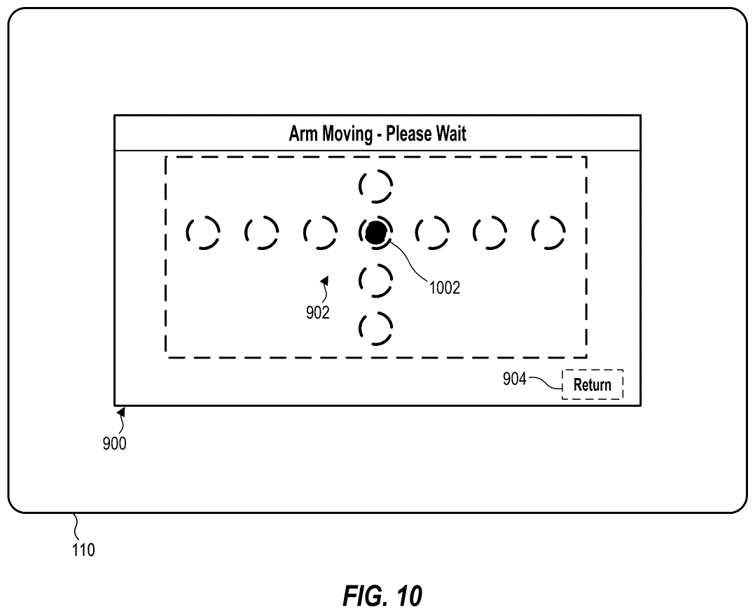

The control interface 110 (or another input system/component associated with the robotic video capture device 102) can be configured to receive user input directed to one or more of the pose points associated with one or more of the preset recording paths. For instance, in the example shown in FIG. 9, the control interface 110 can be configured to receive user input directed to a pose point of the set of pose points 902 depicted on the pose point illumination interface 900 (e.g., touch input selecting one of the circles representing a pose point). FIG. 10 illustrates the control interface 110 depicting the pose point illumination interface 900 after selection of a pose point 1002 from the set of pose points 902. In the example shown in FIG. 10, the pose point illumination interface 900 indicates that the robotic video capture device 102 is moving the robotic arm 104 to cause the pointer light 602 on the head region 120 to illuminate the selected pose point in the surrounding environment (e.g., via the language “Arm Moving—Please Wait”).

FIG. 11 illustrates the robotic video capture device 102 after having moved the robotic arm 104 to position the pointer light 602 on the head region 120 to illuminate the selected pose point 1002 on a surface 1102 (e.g., a floor on which the base 106 of the robotic video capture device 102 stands). FIG. 11 illustrates the pointer light 602 in an activated or on state, whereby the pointer light 602 emits light 1104 to illuminate the pose point 1002 on the surface 1102. With the pose point 1002 illuminated on the surface 1102, a user or operator may place a marker 1106 on the surface 1102 at or near the illumination point to allow marking/indication of the pose point 1002 to persist after the pointer light 602 is deactivated and/or after robotic arm 104 moves from the position shown in FIG. 11. The marker 1106 on the surface 1102 may then be used to coordinating the positioning of subjects to be captured via the robotic video capture device 102 in subsequent recording operations. Leveraging the robotic arm 104 and the pointer light 602 positioned thereon to facilitate marking of pose points for subjects on the surface 1102 can greatly improve the efficiency of setting up a robotic video capture device 102 and can allow operators to avoid manually measuring distance and/or direction from reference points on the robotic video capture device 102 to mark pose points for subjects.

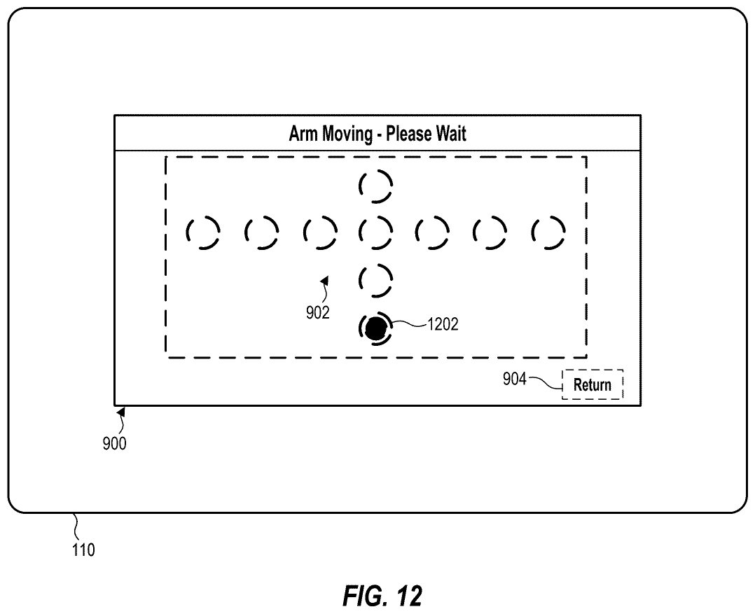

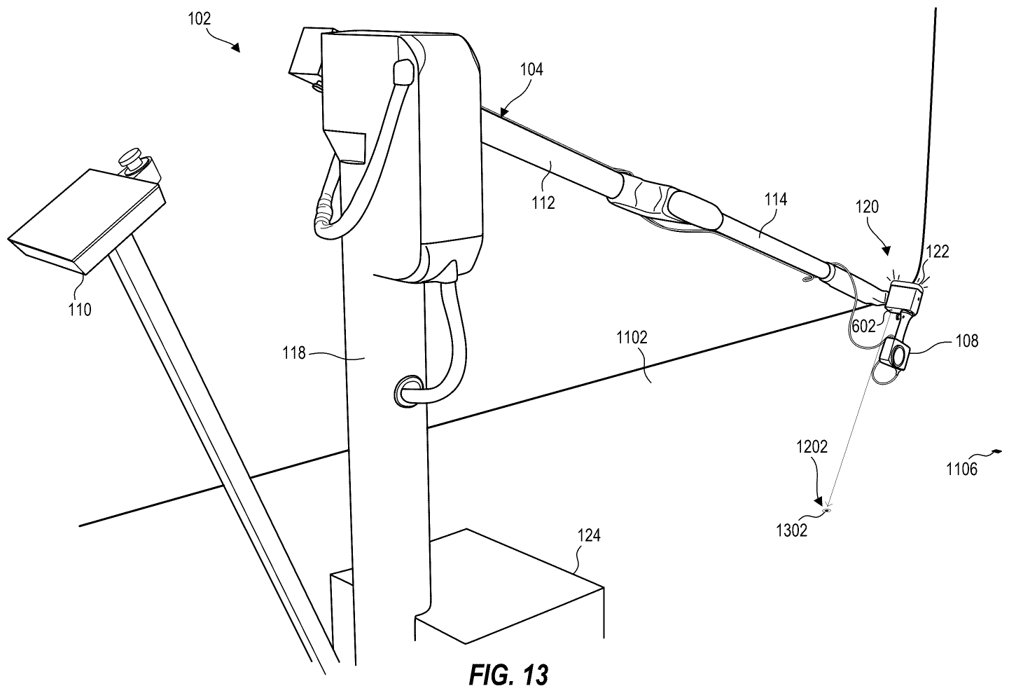

The features described hereinabove with reference to FIGS. 9-11 may be used to facilitate marking of any quantity of pose points. By way of illustrative example, after causing illumination of and marker placement for the pose point 1002, a user may provide additional user input directed to another pose point 1202 shown in the pose point illumination interface 900 presented on the control interface 110, as depicted in FIG. 12. After the control interface 110 receives the user input selecting the pose point 1202, the robotic video capture device 102 may activate the pointer light and move the robotic arm 104 to position the pointer light 602 to illuminate the selected pose point 1202 on the surface 1102, as indicated in FIG. 13. FIG. 13 illustrates another marker 1302 placed on the surface 1102 indicating pose point pose point 1202 in addition to the marker 1106 associated with pose point 1002, indicating that any quantity of pose points may be illuminated and marked using the robotic arm 104 and the pointer light 602 positioned thereon.

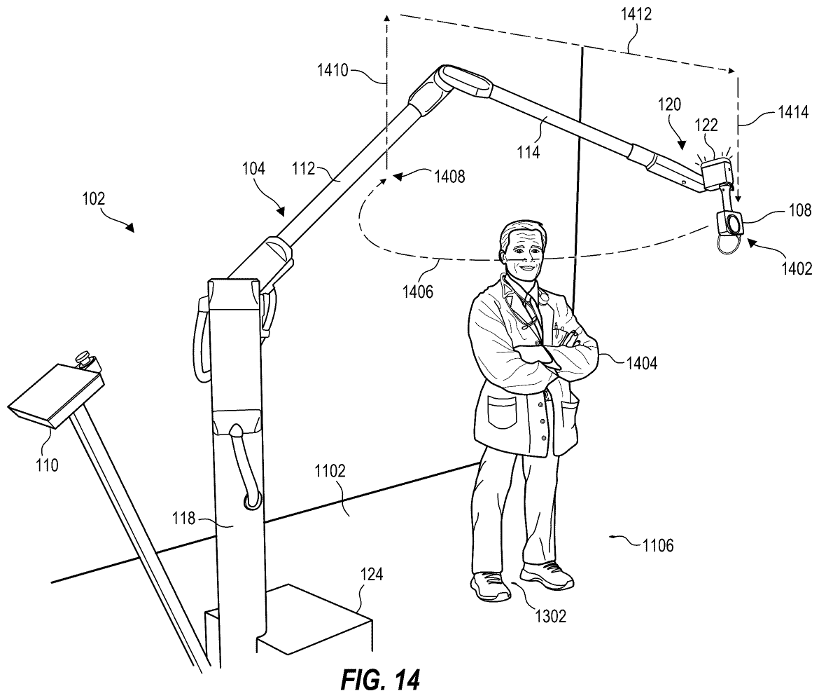

After using the robotic video capture device 102 to mark any desired pose points on the surface 1102, the robotic video capture device 102 may receive user input for deactivating the pointer light 602 and/or for causing the robotic arm 104 to move to another position, such as an initial position occupied by the robotic arm 104 prior to the pose point illumination operations. For instance, a user may select a return control 904 (see FIG. 9) presented on the control interface 110 to deactivate the pointer light 602 and to cause the robotic arm 104 to move to an initial position 1402, as illustrated in FIG. 14.

In some implementations, the initial position 1402 occupied by the robotic arm 104 comprises a start position for one of the preset recording paths associated with the robotic video capture device 102. From such a positioning, a control device associated with the robotic video capture device 102 can receive user input for causing the robotic video capture device 102 to capture a subject. For instance, a user may provide input at the control interface 110 and/or to a user device (e.g., an iPad) supported by the device stand 502 and connected to the hub 124 to cause the robotic video capture device 102 to activate the video capture device 108 and cause the robotic arm 104 to move along the selected predetermined motion path to capture a subject.

FIG. 14 illustrates a subject 1404 positioned at the marker 1302 on the surface 1102. FIG. 14 also conceptually depicts a predetermined motion path 1406 that the robotic arm 104 may cause the video capture device 108 to move along while recording after receipt of the user input for capturing the subject 1404. While moving the video capture device 108 along the predetermined motion path 1406, the robotic arm 104 may control orientation of the video capture device 108 to keep the subject 1404 within the field of view of the video capture device 108. As noted above, the recorded video may be modified, edited, shared, and/or exported using one or more devices of or in communication with the robotic video capture device 102 (e.g., the control interface 110, a user device connected to the hub 124, etc.).

FIG. 14 conceptually depicts an end position 1408 of the video capture device 108 after the robotic arm 104 moves the video capture device 108 in accordance with capturing the subject 1404. After capturing the subject 1404, the robotic arm 104 may return the video capture device 108 from the end position 1408 to the initial position 1402 (or another start position for another preset recording path) in preparation to capture another subject. In some implementations, the robotic arm 104 may return the video capture device 108 to the initial position 1402 using a return path that is different from the predetermined motion path 1406 (or different from reversing along the predetermined motion path 1406). For instance, rather than causing the video capture device 108 to travel in reverse along the predetermined motion path 1406 to reach the initial position 1402, the robotic arm 104 may cause the video capture device 108 (and/or the head region 120 of the robotic arm 104) to elevate to a height higher than the predetermined motion path 1406 and/or than the end position 1408, as indicated in FIG. 14 by elevation path 1410. From the elevated height, the robotic arm 104 may laterally or horizontally move the video capture device 108 (and/or the head region 120) to cause the video capture device 108 to become substantially vertically aligned with the initial position 1402 (or another target position for the video capture device 108), as indicated in FIG. 14 by horizontal motion path 1412. From the position of vertical alignment with the initial position 1402, the robotic arm 104 may then descend the video capture device 108 to cause the video capture device 108 to reach the initial position 1402, as indicated in FIG. 14 by descent path 1414. In some implementations, the cue light 122 and/or one or more speakers of the robotic video capture device 102 may present alarm signals and/or sounds to indicate to users that the video capture device 108 and/or the head region 120 is/are descending, which can cause users to exercise caution so as to avoid collision with the video capture device 108 and/or the head region 120. Utilizing an elevated path to return the video capture device 108 to an initial position (or move the video capture device 108 to another target position), can improve operational safety of the robotic video capture device 102, such as by reducing the likelihood of the robotic arm 104 and/or components connected thereto colliding with users.

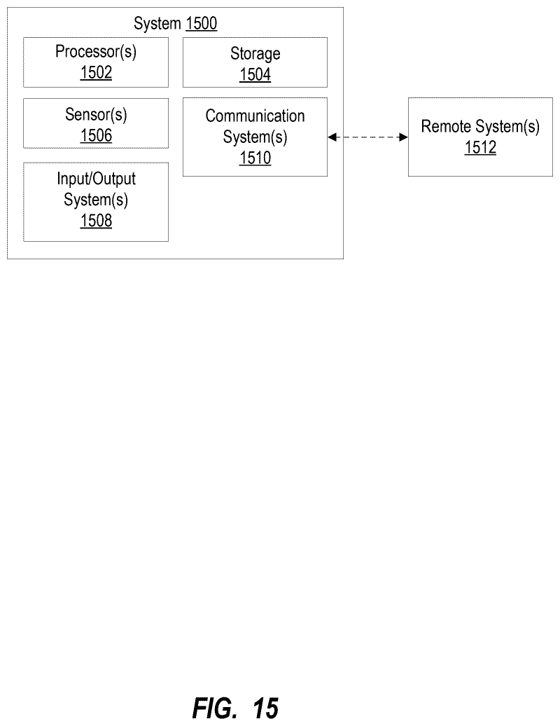

FIG. 15 illustrates example components of a system 1500 that may comprise or implement aspects of one or more disclosed embodiments (e.g., a robotic video capture system can comprise or implement components of a system 1500 as described herein). For example, FIG. 15 illustrates an implementation in which the system 1500 includes processor(s) 1502, storage 1504, sensor(s) 1506, I/O system(s) 1508, and communication system(s) 1510. Although FIG. 15 illustrates a system 1500 as including particular components, one will appreciate, in view of the present disclosure, that a system 1500 may comprise any number of additional or alternative components.

The processor(s) 1502 may comprise one or more sets of electronic circuitries that include any number of logic units, registers, and/or control units to facilitate the execution of computer-readable instructions (e.g., instructions that form a computer program). Processor(s) 1502 can take on various forms, such as CPUs, NPUs, GPUs, or other types of processing units. Such computer-readable instructions may be stored within storage 1504. The storage 1504 may comprise physical system memory and may be volatile, non-volatile, or some combination thereof. Furthermore, storage 1504 may comprise local storage, remote storage (e.g., accessible via communication system(s) 1510 or otherwise), or some combination thereof. Additional details related to processors (e.g., processor(s) 1502) and computer storage media (e.g., storage 1504) will be provided hereinafter.

The processor(s) 1502 may be configured to execute instructions stored within storage 1504 to perform certain actions. In some instances, the actions may rely at least in part on communication system(s) 1510 for receiving data from remote system(s) 1512, which may include, for example, separate systems or computing devices, sensors, servers, and/or others. The communications system(s) 1510 may comprise any combination of software or hardware components that are operable to facilitate communication between on-system components/devices and/or with off-system components/devices. For example, the communications system(s) 1510 may comprise ports, buses, or other physical connection apparatuses for communicating with other devices/components. Additionally, or alternatively, the communications system(s) 1510 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 15 illustrates that a system 1500 may comprise or be in communication with sensor(s) 1506. Sensor(s) 1506 may comprise any device for capturing or measuring data representative of perceivable phenomenon. By way of non-limiting example, the sensor(s) 1506 may comprise one or more image sensors, microphones, thermometers, barometers, magnetometers, accelerometers, gyroscopes, position trackers/sensors, and/or others.

Furthermore, FIG. 15 illustrates that a system 1500 may comprise or be in communication with I/O system(s) 1508. I/O system(s) 1508 may include any type of input or output device such as, by way of non-limiting example, a display, a touch screen, a mouse, a keyboard, a controller, and/or others, without limitation.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “computer-readable recording media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

Disclosed embodiments include at least those described in the following numbered clauses:

Clause 1. An enclosure for a robotic video capture device, comprising: a first case shell, comprising: a first plurality of shell walls that define a first interior, a first open side, and a second open side; a first set of interlock features; and a first bracket assembly at least partially positioned within the first interior, the first bracket assembly comprising a first set of engagement features configured to engage with a first part of a base of the robotic video capture device when the first part of the base is positioned within the first open side defined by the first plurality of shell walls; and a second case shell, comprising: a second plurality of shell walls that define a second interior, a third open side, and a fourth open side; a second set of interlock features configured to selectively engage with the first set of interlock features to secure the first case shell to the second case shell when the second open side aligns with the fourth open side; a second bracket assembly at least partially positioned within the second interior, the second bracket assembly comprising a second set of engagement features configured to engage with a second part of the base when the second part of the base is positioned within the third open side defined by the second plurality of shell walls; and a support platform arranged opposite the third open side within the second interior, the support platform being configured to support an arm extending from the base of the robotic video capture device when (i) the first bracket assembly is engaged with the first part of the base, (ii) the second bracket assembly is engaged with the second part of the base, (iii) the first set of interlock features is engaged with the second set of interlock features, and (iv) the enclosure is tilted such that the first case shell is vertically positioned over the second case shell.

Clause 2. The enclosure of clause 1, wherein the first plurality of shell walls comprises a first shell wall, a second shell wall, a third shell wall, and a fourth shell wall, wherein the second shell wall, the third shell wall, and the fourth shell wall are connected to respective edges of the first shell wall and are substantially perpendicular to the first shell wall.

Clause 3. The enclosure of clause 2, wherein the second plurality of shell walls comprises a fifth shell wall, a sixth shell wall, a seventh shell wall, and an eighth shell wall, wherein the sixth shell wall, the seventh shell wall, and the eighth shell wall are connected to respective edges of the fifth shell wall and are substantially perpendicular to the fifth shell wall.

Clause 4. The enclosure of clause 3, wherein, when the first set of interlock features is engaged with the second set of interlock features, the second shell wall interfaces with the sixth shell wall, the third shell wall interfaces with the seventh shell wall, and the fourth shell wall interfaces with the eighth shell wall.

Clause 5. The enclosure of clause 4, wherein the first set of interlock features is arranged on the second shell wall and the fourth shell wall, and wherein the second set of interlock features is arranged on the sixth shell wall and the eighth shell wall.

Clause 6. The enclosure of any one of clauses 3 through 5, further comprising a set of roller elements connected to the fifth shell wall of the second plurality of shell walls.

Clause 7. The enclosure of clause 6, wherein the base comprises a set of leveling features.

Clause 8. The enclosure of clause 7, wherein the base omits roller elements.

Clause 9. The enclosure of any one of clauses 6 through 8, further comprising a set of handles connected to the sixth shell wall, the seventh shell wall, and/or the eighth shell wall.

Clause 10. The enclosure of any one of clauses 3 through 9, further comprising a base plate retainer connected to the third shell wall, the base plate retainer being configured to receive a base plate of a device stand.

Clause 11. The enclosure of clause 1, wherein: the first set of engagement features comprises a first set of protrusions defined by the first bracket assembly, and the second set of engagement features comprises a second set of protrusions defined by the second bracket assembly.

Clause 12. An enclosure for a robotic video capture device, comprising: a first case shell, comprising: a first plurality of shell walls that define a first interior, a first open side, and a second open side; a first set of interlock features; and a first engagement mechanism configured to engage with a first part of a base of the robotic video capture device when the first part of the base is positioned within the first open side defined by the first plurality of shell walls; and a second case shell, comprising: a second plurality of shell walls that define a second interior, a third open side, and a fourth open side; a second set of interlock features configured to selectively engage with the first set of interlock features to secure the first case shell to the second case shell when the second open side aligns with the fourth open side; a second engagement mechanism configured to engage with a second part of the base when the second part of the base is positioned within the third open side defined by the second plurality of shell walls; and a set of roller elements connected to a shell wall of the second plurality of shell walls.

Clause 13. The enclosure of clause 12, wherein the set of roller elements is configured to support the robotic video capture device when (i) the first engagement mechanism is engaged with the first part of the base, (ii) the second engagement mechanism is engaged with the second part of the base, (iii) the first set of interlock features is engaged with the second set of interlock features, and (iv) the enclosure is tilted such that the first case shell is vertically positioned over the second case shell.

Clause 14. The enclosure of clause 12 or clause 13, further comprising a set of handles connected to the second case shell, wherein the set of handles is configured to facilitate repositioning of the enclosure from a first position to a second position and vice-versa when (i) the first engagement mechanism is engaged with the first part of the base, (ii) the second engagement mechanism is engaged with the second part of the base, and (iii) the first set of interlock features is engaged with the second set of interlock features, wherein the first position is characterized by the set of roller elements supporting a weight of the enclosure, and wherein the second position is characterized by the base of the robotic video capture device supporting the weight of the enclosure.

Clause 15. The enclosure of clause 14, wherein the base omits roller elements.

Clause 16. An enclosure for a robotic video capture device, comprising: a first case shell, comprising: a first plurality of shell walls that define a first interior, a first open side, and a second open side; a first set of interlock features; a first engagement mechanism configured to engage with a first part of a base of the robotic video capture device when the first part of the base is positioned within the first open side defined by the first plurality of shell walls; and a base plate retainer arranged opposite the first open side within the first interior, the base plate retainer being configured to receive a base plate of a device stand; and a second case shell, comprising: a second plurality of shell walls that define a second interior, a third open side, and a fourth open side; a second set of interlock features configured to selectively engage with the first set of interlock features to secure the first case shell to the second case shell when the second open side aligns with the fourth open side; and a second engagement mechanism configured to engage with a second part of the base when the second part of the base is positioned within the third open side defined by the second plurality of shell walls.

Clause 17. The enclosure of clause 16, wherein the first case shell further comprises a receiver panel at least partially positioned within the first interior, the receiver panel defining a riser slot for receiving a riser of the device stand.

Clause 18. The enclosure of clause 17, wherein the receiver panel further comprises one or more additional slots configured to receive one or more components of the robotic video capture device.

Clause 19. The enclosure of clause 17 or clause 18, wherein the receiver panel further comprises a riser retention feature configured to retain the riser within the riser slot.

Clause 20. The enclosure of clause 19, wherein the riser retention feature comprises a bungee ball fastener.

Clause 21. A robotic video capture device, comprising: a robotic arm connected to a base; a video capture device connected to the robotic arm, wherein positioning of the video capture device is modifiable via the robotic arm; a pointer light connected to the robotic arm, wherein positioning of the pointer light is modifiable via the robotic arm; one or more control interfaces comprising a display and one or more input systems; one or more processors; and one or more computer-readable recording media that store instructions that are executable by the one or more processors to configure the robotic video capture device to: receive, via the one or more input systems, user input directed to triggering illumination of a pose point via the pointer light, wherein the pose point indicates intended positioning on a surface for one or more subjects to be captured via the video capture device; after receiving the user input, control the robotic arm to position the pointer light to illuminate the pose point on the surface; and activate the pointer light to illuminate the pose point on the surface.

Clause 22. The robotic video capture device of clause 21, wherein the robotic arm comprises a 6 degree of freedom robotic arm.

Clause 23. The robotic video capture device of clause 21 or clause 22, wherein the pointer light comprises a laser.

Clause 24. The robotic video capture device of any one of clauses 21 through 23, wherein the robotic arm comprises a head region.

Clause 25. The robotic video capture device of clause 24, wherein the video capture device and the pointer light are connected to the head region.

Clause 26. The robotic video capture device of clause 25, further comprises a cue light that is connected to the head region.

Clause 27. The robotic video capture device of any one of clauses 21 through 26, wherein the pose point comprises one of a plurality of pose points indicating different intended positionings on the surface for the one or more subjects to be captured via the video capture device.

Clause 28. The robotic video capture device of clause 27, wherein the instructions are executable by the one or more processors to configure the robotic video capture device to present, on the display, a representation of the plurality of pose points.

Clause 29. The robotic video capture device of clause 28, wherein the user input includes a selection of the pose point from the plurality of pose points as depicted in the representation of the plurality of pose points.

Clause 30. The robotic video capture device of any one of clauses 21 through 29, wherein the surface comprises a surface on which the base is standing.

Clause 31. The robotic video capture device of any one of clauses 21 through 30, wherein the instructions are executable by the one or more processors to configure the robotic video capture device to: after activating the pointer light to illuminate the pose point on the surface, receive second user input directed to returning the robotic arm to an initial position; and after receiving the second user input, deactivate the pointer light and control the robotic arm to return the robotic arm to the initial position.

Clause 32. The robotic video capture device of clause 31, wherein the instructions are executable by the one or more processors to configure the robotic video capture device to: after deactivating the pointer light and controlling the robotic arm to return the robotic arm to the initial position, receive third user input directed to capturing a subject; after receiving the third user input, control the robotic arm to move the robotic arm according to a predetermined motion path; and activate the video capture device to record the subject as the robotic arm moves according to the predetermined motion path.

Clause 33. A method, comprising: receiving, via one or more input systems of a robotic video capture device, user input directed to triggering illumination of a pose point via a pointer light connected to a robotic arm of the robotic video capture device, the robotic arm being connected to a base, wherein the pose point indicates intended positioning on a surface for one or more subjects to be captured via a video capture device connected to the robotic arm; after receiving the user input, controlling the robotic arm to position the pointer light to illuminate the pose point on the surface; and activating the pointer light to illuminate the pose point on the surface.

Clause 34. The method of clause 33, wherein the pointer light comprises a laser.

Clause 35. The method of clause 33 or clause 34, wherein the pose point comprises one of a plurality of pose points indicating different intended positionings on the surface for the one or more subjects to be captured via the video capture device.

Clause 36. The method of clause 35, further comprising presenting, on a display of the robotic video capture device, a representation of the plurality of pose points.

Clause 37. The method of clause 36, wherein the user input includes a selection of the pose point from the plurality of pose points as depicted in the representation of the plurality of pose points.

Clause 38. The method of any one of clauses 33 through 37, further comprising: after activating the pointer light to illuminate the pose point on the surface, receiving second user input directed to returning the robotic arm to an initial position; and after receiving the second user input, deactivating the pointer light and control the robotic arm to return the robotic arm to the initial position.

Clause 39. The method of clause 38, further comprising: after deactivating the pointer light and controlling the robotic arm to return the robotic arm to the initial position, receiving third user input directed to capturing a subject; after receiving the third user input, controlling the robotic arm to move the robotic arm according to a predetermined motion path; and activating the video capture device to record the subject as the robotic arm moves according to the predetermined motion path.

Clause 40. One or more computer-readable recording media that store instructions that are executable by one or more processors of a robotic video capture device to configure the robotic video capture device to: receive, via one or more input systems of a robotic video capture device, user input directed to triggering illumination of a pose point via a pointer light connected to a robotic arm of the robotic video capture device, wherein the pose point indicates intended positioning on a surface for one or more subjects to be captured via a video capture device connected to the robotic arm; after receiving the user input, control the robotic arm to position the pointer light to illuminate the pose point on the surface; and activate the pointer light to illuminate the pose point on the surface.

It will be appreciated to those skilled in the art that the embodiments described herein are provided by way of example only and are not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is currently claimed is:

1. An enclosure for a robotic video capture device, comprising:
a first case shell, comprising:
a first plurality of shell walls that define a first interior, a first open side, and a second open side;
a first set of interlock features; and
a first bracket assembly at least partially positioned within the first interior, the first bracket assembly comprising a first set of engagement features configured to engage with a first part of a base of the robotic video capture device when the first part of the base is positioned within the first open side defined by the first plurality of shell walls; and
a second case shell, comprising:
a second plurality of shell walls that define a second interior, a third open side, and a fourth open side;
a second set of interlock features configured to selectively engage with the first set of interlock features to secure the first case shell to the second case shell when the second open side aligns with the fourth open side;
a second bracket assembly at least partially positioned within the second interior, the second bracket assembly comprising a second set of engagement features configured to engage with a second part of the base when the second part of the base is positioned within the third open side defined by the second plurality of shell walls; and
a support platform arranged opposite the third open side within the second interior, the support platform being configured to support an arm extending from the base of the robotic video capture device when (i) the first bracket assembly is engaged with the first part of the base, (ii) the second bracket assembly is engaged with the second part of the base, (iii) the first set of interlock features is engaged with the second set of interlock features, and (iv) the enclosure is tilted such that the first case shell is vertically positioned over the second case shell.

2. The enclosure of claim 1, wherein the first plurality of shell walls comprises a first shell wall, a second shell wall, a third shell wall, and a fourth shell wall, wherein the second shell wall, the third shell wall, and the fourth shell wall are connected to respective edges of the first shell wall and are substantially perpendicular to the first shell wall.

3. The enclosure of claim 2, wherein the second plurality of shell walls comprises a fifth shell wall, a sixth shell wall, a seventh shell wall, and an eighth shell wall, wherein the sixth shell wall, the seventh shell wall, and the eighth shell wall are connected to respective edges of the fifth shell wall and are substantially perpendicular to the fifth shell wall.

4. The enclosure of claim 3, wherein, when the first set of interlock features is engaged with the second set of interlock features, the second shell wall interfaces with the sixth shell wall, the third shell wall interfaces with the seventh shell wall, and the fourth shell wall interfaces with the eighth shell wall.

5. The enclosure of claim 4, wherein the first set of interlock features is arranged on the second shell wall and the fourth shell wall, and wherein the second set of interlock features is arranged on the sixth shell wall and the eighth shell wall.

6. The enclosure of claim 3, further comprising a set of roller elements connected to the fifth shell wall of the second plurality of shell walls.

7. The enclosure of claim 6, wherein the base comprises a set of leveling features.

8. The enclosure of claim 7, wherein the base omits roller elements.

9. The enclosure of claim 6, further comprising a set of handles connected to the sixth shell wall, the seventh shell wall, and/or the eighth shell wall.

10. The enclosure of claim 3, further comprising a base plate retainer connected to the third shell wall, the base plate retainer being configured to receive a base plate of a device stand.

11. The enclosure of claim 1, wherein:
the first set of engagement features comprises a first set of protrusions defined by the first bracket assembly, and
the second set of engagement features comprises a second set of protrusions defined by the second bracket assembly.

12. An enclosure for a robotic video capture device, comprising:
a first case shell, comprising:
a first plurality of shell walls that define a first interior, a first open side, and a second open side;
a first set of interlock features; and
a first engagement mechanism configured to engage with a first part of a base of the robotic video capture device when the first part of the base is positioned within the first open side defined by the first plurality of shell walls; and
a second case shell, comprising:
a second plurality of shell walls that define a second interior, a third open side, and a fourth open side;
a second set of interlock features configured to selectively engage with the first set of interlock features to secure the first case shell to the second case shell when the second open side aligns with the fourth open side;
a second engagement mechanism configured to engage with a second part of the base when the second part of the base is positioned within the third open side defined by the second plurality of shell walls; and
a set of roller elements connected to a shell wall of the second plurality of shell walls.

13. The enclosure of claim 12, wherein the set of roller elements is configured to support the robotic video capture device when (i) the first engagement mechanism is engaged with the first part of the base, (ii) the second engagement mechanism is engaged with the second part of the base, (iii) the first set of interlock features is engaged with the second set of interlock features, and (iv) the enclosure is tilted such that the first case shell is vertically positioned over the second case shell.

14. The enclosure of claim 12, further comprising a set of handles connected to the second case shell, wherein the set of handles is configured to facilitate repositioning of the enclosure from a first position to a second position and vice-versa when (i) the first engagement mechanism is engaged with the first part of the base, (ii) the second engagement mechanism is engaged with the second part of the base, and (iii) the first set of interlock features is engaged with the second set of interlock features, wherein the first position is characterized by the set of roller elements supporting a weight of the enclosure, and wherein the second position is characterized by the base of the robotic video capture device supporting the weight of the enclosure.

15. The enclosure of claim 14, wherein the base omits roller elements.

16. An enclosure for a robotic video capture device, comprising:
a first case shell, comprising:
a first plurality of shell walls that define a first interior, a first open side, and a second open side;
a first set of interlock features;
a first engagement mechanism configured to engage with a first part of a base of the robotic video capture device when the first part of the base is positioned within the first open side defined by the first plurality of shell walls; and
a base plate retainer arranged opposite the first open side within the first interior, the base plate retainer being configured to receive a base plate of a device stand; and
a second case shell, comprising:
a second plurality of shell walls that define a second interior, a third open side, and a fourth open side;
a second set of interlock features configured to selectively engage with the first set of interlock features to secure the first case shell to the second case shell when the second open side aligns with the fourth open side; and
a second engagement mechanism configured to engage with a second part of the base when the second part of the base is positioned within the third open side defined by the second plurality of shell walls.

17. The enclosure of claim 16, wherein the first case shell further comprises a receiver panel at least partially positioned within the first interior, the receiver panel defining a riser slot for receiving a riser of the device stand.

18. The enclosure of claim 17, wherein the receiver panel further comprises one or more additional slots configured to receive one or more components of the robotic video capture device.

19. The enclosure of claim 17, wherein the receiver panel further comprises a riser retention feature configured to retain the riser within the riser slot.

20. The enclosure of claim 19, wherein the riser retention feature comprises a bungee ball fastener.
